(19) United States
(12) Patent Application Publication
(10) Pub. No.: US 2009/0060046 A1
(43) Pub. Date: Mar. 5, 2009

(54) Method and apparatus for improving the quality of a transmitted video signal

(75) Inventor: Gary Dean Cole, Corona, CA (US)

Correspondence Address: THE HECKER LAW GROUP, 1925 CENTURY PARK EAST, SUITE 2300, LOS ANGELES, CA, 90067, US

(73) Assignee: RGB Systems, Inc.

(21) Appl. No.: 11/897,547

(22) Filed: Aug. 29, 2007

(51) Int. Cl. H04B 1/66

(52) U.S. Cl. 375/240.21; 375/E07.279

(57) ABSTRACT

A feedback circuit for restoration of DC reference levels in video signals is presented. In one or more embodiments, a DC sample pulse is generated representing the back porch of an incoming video signal. A sample and hold circuit, which is controlled by the DC sample pulse, obtains the correct offset voltage in the output signal during this back porch period. The offset voltage feeds back through an integrating node in front of the circuit causing an amplifier to compensate for the signal offset thereby restoring the video signal to its proper DC voltage level with respect to ground.

### FIELD OF THE INVENTION

This invention relates to the field of video transmission. More specifically the invention relates to a method and apparatus for improving the quality of a transmitted video signal by detecting DC reference levels in video signals incorporating tri-level and other synchronization signal formats.

### BACKGROUND

Cables are used to convey electronic video signals from a source device to a destination device, e.g., a display device such as a display screen or video projector. Usually, a cable does not accurately convey the signal because of losses that accumulate along the cable path. These losses, sometimes referred to as insertion losses, are primarily due to the physical characteristics of the transmission cable and sometimes due to imperfections in the cable construction. A cable is a physical device and most physical devices exhibit some losses when a signal is conveyed through them. Thus, longer length transmission cables typically exhibit more loss than shorter length cables. Therefore, there exists a length limit for each transmission cable medium after which a transmitted video signal may no longer be acceptable.

Video signals may be transmitted either in digital or analog formats. For digital video signals, such as those used to display computer video, cable insertion loss is generally not an issue because the digital signal can be recovered so long as discernable digital pulses are received at the receiving station. However, for analog signals such as NTSC (National Television Standards Committee) video signals, the signal comprises varying voltages, and voltages are affected by wire length, connectors, materials, manufacturing processes, and other conditions.

Insertion loss varies with the type of transmission medium. For example, coaxial cables exhibit fewer insertion losses than twisted pair cables, thus coaxial cables are a preferred medium for video transmission, particularly for transmission of high resolution (i.e., broadband) video signals. However, coaxial cables are more expensive and difficult to install compared to twisted pair cables.

Historically, the significant insertion losses exhibited by twisted pair cables limited their use to transmission of low-resolution video (i.e., less than 10 MHz) signals. However, twisted pair cables have one distinct advantage over coaxial cables, i.e., cost/performance ratio. Dollar-for-dollar, twisted pair cables are significantly cheaper (in both purchase and installation) than coaxial or fiber (i.e., fiber optic) cables. In addition, a standard twisted pair cable contains four pairs of conductors in a single cable so that the actual cost per pair is one-quarter of the per-foot price.

Analog video signals may take a variety of forms, such as the forms specified by the C-Video (component video), S-Video, or YUV (or YIQ) specifications, and may adhere to a variety of different color models. A color model (also color space) specifies colors in some standard, generally accepted way. For example, the RGB color model specifies color by means of separate red (“R”), green (“G”) and blue (“B”) components.

High-resolution analog video signals that are defined in terms of separate components, such as RGB video signals, require that each color component be transmitted separately to a destination device. For such transmission, a coaxial cable setup requires three separate coaxial cables, one for each color component. In contrast, a twisted pair setup only requires one twisted pair cable for all the video components, because standard twisted pair cable includes four separate twisted pairs. For example, each of the three color components of the RGB format video signal may be transmitted over one out of the four twisted pair conductors in the cable, and the last (i.e. fourth) twisted pair may be used for transmission of other signals, such as power and/or digital control or other data.

Prior art video transmission systems can satisfactorily transmit analog video signals over twisted pair cable a distance of only approximately 300 feet because of the high insertion loss in the cable. To communicate video over distances greater than 300 feet with current twisted pair technology, multiple transmitter/receiver pairs, each capable of transmitting 300 feet, must be serially connected to achieve the required distance. Such an arrangement results in significant cost and waste. For example, the cost of the additional equipment may become prohibitive; each additional transmitter/receiver combination in the transmission path results in wasted energy; and the video quality degrades as it is passed from one device to another. In addition, video systems are moving to higher and higher video resolutions, which traditional twisted pair systems cannot handle.

Further, when each component of a video signal is transmitted over a separate twisted pair conductor over long distances, skew or delay between the separate video component signals becomes an additional issue that must be accounted for. Skew correction is important because proper video signal reproduction requires that the separate component signals arrive at the ultimate destination at the same time. For example, when the R, G, and B components of a high-resolution video are transmitted on separate conductors, the components must synchronize up in time at the receiving station to prevent distortion in the video signal when it is displayed at the destination.

In addition, certain video signal standards require that the “front porch” and “back porch” portions of the signal (i.e., the video signal level before and after a horizontal synchronization signal) to be at a DC ground level. However, it is common to find video sources that are not referenced to ground. For example, some video sources may have a floating DC reference level or be biased above or below ground. Prior art systems use methods such as AC coupling (using capacitors) to remove the DC content from a received video signal, but these methods do not adequately operate on signals that use a floating ground. For such signals, leakages on the output side of the coupling capacitors may cause the DC operating point to drift. Therefore, capacitive coupling and other DC compensation methods of the prior art have drawbacks which can degrade video signal quality.

Amplifiers do not reproduce their input signal perfectly. One significant error is a slight DC offset, which adds up to a large value after several stages. This DC offset will bias the signal in such a manner that it cannot be displayed properly. Some means of bringing the DC level back to its expected voltage of 0 volts relative to a display device is required.

### SUMMARY OF INVENTION

The invention comprises a transmitter and a receiver tandem coupled over twisted pair cables for communication of high-resolution video signals over greater distances than currently possible with prior art systems. To achieve such an extended transmission range, one or more embodiments of the present invention include a DC restore circuit in the transmitter and/or the receiver. The DC restore circuit essentially provides a compensating current, which is integrated to counteract DC offsets in the voltage of the transmitted video signal.

In one or more embodiments of the present invention, a DC restore circuit is included in the transmitter, in the receiver, or both. In the transmitter, if the DC offset of the video source is unknown, the DC restore circuit centers the video signal received from the video source between the maximum and minimum points of the signal's dynamic range, which improves the quality of the transmitted signal. In the receiver, the DC restore circuit minimizes the DC offset of the output video signal of the receiver, which leads to robust system operation.

One or more embodiments of the present invention are configured to automatically detect when a video signal is present at the receiver and to automatically adjust the video signals for a variety of losses in the video signal quality. For example, in one or more embodiments, when a twisted pair cable is connected between a transmitter and a receiver of the present invention, the receiver detects whether there is a video signal in the line and automatically adjusts for DC error, AC loss, and skew error in the video signal. Methods used for compensation for DC error, AC loss, and skew error in one or more embodiments of the invention are described in U.S. patent application Ser. No. 11/309120 filed Jun. 23, 2006 entitled “Method and Apparatus for Automatic Compensation of Skew in Video Transmitted over Multiple Conductors,” U.S. patent application Ser. No. 11/309123 filed Jun. 23, 2006 entitled “Method and Apparatus for Automatic Reduction of Noise in Video Transmitted over Conductors,” U.S. patent application Ser. No. 11/309558 filed Aug. 22, 2006 entitled “Method and Apparatus for DC Restoration Using Feedback,” and U.S. patent application Ser. No. 11/557938 filed Nov. 7, 2006 entitled “Method and Apparatus for Video Transmission over Long Distances Using Twisted Pair Cables,” the specifications of which are incorporated by reference herein.

In one or more embodiments, signal adjustment is done primarily with reference to a synchronization signal that forms part of the transmitted video signal. When the receiver is first coupled to the line, it sets its loop gains to maximum to facilitate recovery of the synchronization signal. After the synchronization signal is detected, the receiver adjusts the DC and/or AC signal amplitude and peaking until the synchronization signal is restored to its proper level. In other embodiments, signals other than a synchronization signal may serve as the reference for adjustment.

Further objects, features, and advantages of the present invention over the prior art will become apparent from the detailed description of the drawings that follows, when considered with the attached figures.

### BRIEF DESCRIPTION OF THE DRAWINGS

FIG. 1 illustrates a long distance twisted pair transmission apparatus in accordance with an embodiment of the present invention.

FIG. 2 illustrates an allocation of twisted pair cable conductors for various video formats in accordance with an embodiment of the present invention.

FIG. 3 illustrates an allocation of twisted pair cable conductors for A/V communications in accordance with an embodiment of the present invention.

FIG. 4 is a block diagram illustrating the architecture of a transmitter in accordance with an embodiment of the present invention.

FIG. 5 illustrates sync signal generation from the green video input component in accordance with an embodiment of the invention.

FIG. 6 is a block diagram illustrating the architecture of an example receiver in accordance with an embodiment of the present invention.

FIG. 7 illustrates a sync stripper circuit in accordance with an embodiment of the present invention.

FIG. 8 illustrates an exemplary sample pulse generator is in accordance with an embodiment of the present invention.

FIG. 9 illustrates an exemplary DC offset correction circuit in accordance with an embodiment of the present invention.

FIG. 10 illustrates method steps used to characterize an input synchronization signal in accordance with an embodiment of the present invention.

FIG. 11 illustrates method steps used to characterize an input synchronization signal in accordance with an embodiment of the present invention.

FIG. 12 illustrates method steps used to characterize an input synchronization signal in accordance with an embodiment of the present invention.

### DETAILED DESCRIPTION OF THE INVENTION

The invention comprises a method and apparatus for restoration of DC reference voltage levels in video signals transmitted over long distances using twisted pair conductors. In the following description, numerous specific details are set forth in order to provide a more thorough description of the present invention. It will be apparent, however, to one skilled in the art, that the present invention may be practiced without these specific details. In other instances, well-known features have not been described in detail so as not to obscure the invention.

In one or more embodiments, the invention comprises a transmitter and a receiver tandem coupled together over a twisted pair cable for communication of video signals, including composite video, component video, S-Video, computer-video, and other high resolution video signals, over long distances. Embodiments of the present invention include one or more DC restore circuits to improve the quality of the transmitted video signals and to provide output video that is compatible with multiple display systems.

Embodiments of the present invention may be configured for “plug and play” operation. In such embodiments, when a twisted pair cable is connected between the transmitter and the receiver, with a video signal present, the system detects the presence of the video signals and automatically adjusts for DC error, AC loss, and skew error. If no video signal is present, all video path circuits maintain operation in a stable linear operating region. In addition, embodiments of the present invention may include noise-filtering circuits for enhanced restoration of the video signal. In addition, each receiver may include a video loop out for daisy chaining or any other type of linking to other receivers and/or transmitters.

In one or more embodiments, restoration of a received video signal is based on a synchronization signal that is included in the received video signal. In one ore more embodiments, when the receiver is coupled to the transmitter via a twisted pair cable, the receiver initially attempts to detect the synchronization signal. The receiver adjusts loop gains of its amplifier circuitry to maximum while looking for the synchronization signal. In one or more embodiments, the receiver's loop gains remain at maximum until the synchronization signal is detected. Once the synchronization signal is detected or re-established, the receiver adjusts the DC and/or AC signal amplitude and peaking until the synchronization signal is restored to its proper level, which is preferably a known quantity.

In one or more embodiments, the receiver employs a closed loop feedback system around the video signal that automatically samples the signal with respect to ground. Meanwhile, the synchronization signal is restored to the proper level, appropriate compensation is applied to compensate for transmission losses, and skew between the video components is measured and corrected. Methods used for compensation for DC error, AC loss, and skew error in one or more embodiments of the invention are described in U.S. patent application Ser. No. 11/309120 filed Jun. 23, 2006 entitled “Method and Apparatus for Automatic Compensation of Skew in Video Transmitted over Multiple Conductors,” U.S. patent application Ser. No. 11/309123 filed Jun. 23, 2006 entitled “Method and Apparatus for Automatic Reduction of Noise in Video Transmitted over Conductors,” U.S. patent application Ser. No. 11/309558 filed Aug. 22, 2006 entitled “Method and Apparatus for DC Restoration Using Feedback,” and U.S. patent application Ser. No. 11/557938 filed Nov. 7, 2006 entitled “Method and Apparatus for Video Transmission over Long Distances Using Twisted Pair Cables,” the specifications of which are incorporated by reference herein.

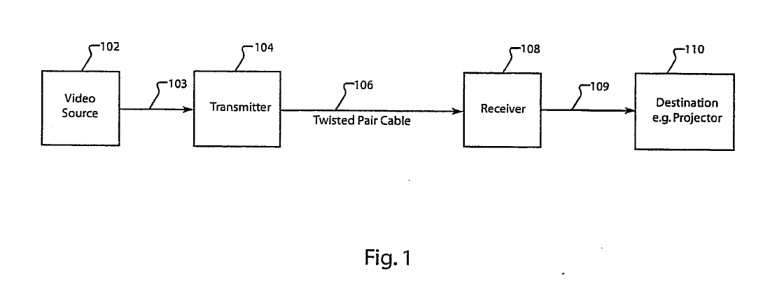

An embodiment of a twisted pair transmission system comprising the present invention is illustrated in FIG. 1. As illustrated, the twisted pair transmission system comprises transmitter 104, twisted pair cable 106, and receiver 108. Transmitter 104 is configured to handle most video formats originating from video source 102. Cable 103 couples the video and audio signals from source 102 to transmitter 104. Cable 103 may be any combination of different types of conductors appropriate for coupling the video signal from the source 102 to Transmitter 104.

For example, cable 103 may comprise a combination of conductors for video and audio. The video conductors may be VGA cables, coaxial cables, twisted pair cables, etc, for carrying composite video, S-Video and high resolution computer-video, for example. Thus, an embodiment of transmitter 104 may comprise a composite video input on a female BNC connector, an S-Video input on a female 4-pin mini DIN and a computer-video input on a female 15-pin HD connector, for example. The audio conductors may be standard audio patch cables with RCA connectors, for example.

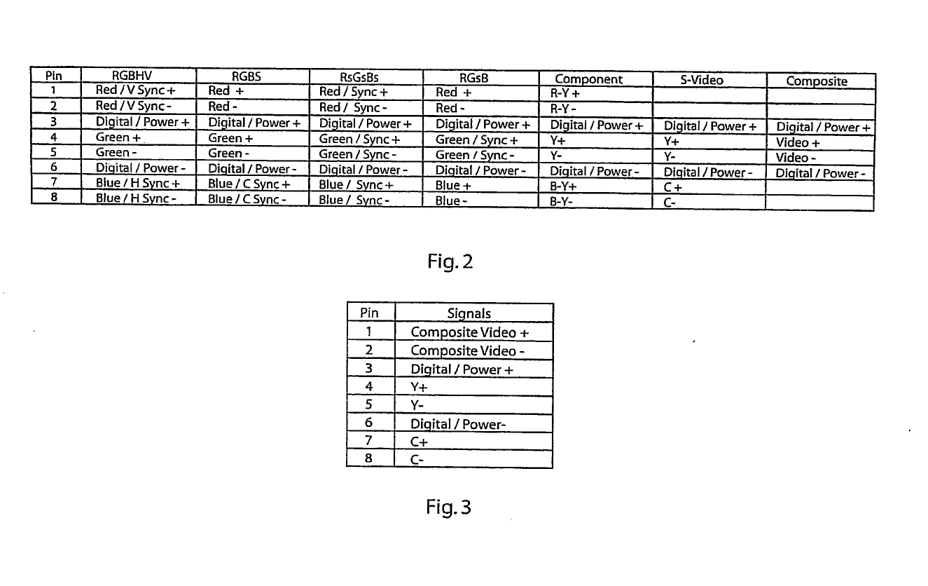

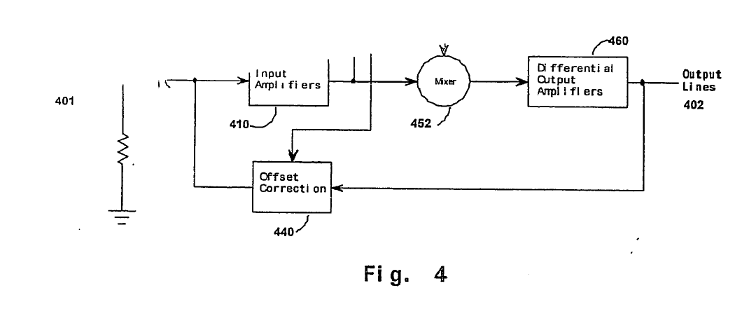

Twisted pair cable 106 may be configured as a single twisted pair cable or as a bundle of multiple twisted pairs, depending on the configuration of transmitter 104 and receiver 108. A commonly used cable comprises a bundle of four twisted pairs. The connectors on both ends of the cables may be similar, e.g., male RJ-45 connectors to mate with female RJ-45 connectors on the transmitter and receiver. Note that the connectors on the ends of cable 106 are preferably configured to mate with the connector on transmitter 104 at one end and receiver 108 at the other end. FIGS. 2 and 3 are illustrations of example allocations of conductors of twisted pair cable 106 that may be used in one or more embodiments of the invention.

In the embodiments of FIGS. 2 and 3, each twisted pair cable bundle comprises four pairs of conductors. Each cable bundle may be terminated at each end with 8-pin connectors. Each pin is connected to one of the conductors. In the descriptions that follow, and as illustrated in FIGS. 2 and 3, the first conductor pair will be referred to as comprising pins 1 and 2; the second conductor pair as comprising pins 4 and 5; the third conductor pair as comprising pins 7 and 8; and the fourth conductor pair as comprising pins 3 and 6.

In one or more embodiments, one of the four conductor pairs, for example, the fourth pair (i.e. pins 3 and 6), may be used for digital communication and for power transfer. Power transfer may be necessary between transmitter 104 and receiver 108 when the location of one of the devices (i.e. transmitter or receiver) is too remote from an external power source. For example, in some installations, receiver 108 is generally located closer to display device 110 and may have easy access to the external power source used to power the display device. In such configuration, it may be necessary to transfer power from receiver 108 to transmitter 104, which may be located in an obscure area and too remote from an independent power source.

The remaining conductor pairs may be allocated as illustrated in FIGS. 2 and 3, depending on the video format. Note that the pin allocations used herein are for illustrative purposes and for convenience in separating the color components. For example, for transmission of RGB video signals, the signals may be allocated such that pins I and 2 may carry the differential red signals (i.e. red+ and red−); pins 4 and 5 may carry the differential green signals (i.e. green+ and green−); pins 7 and 8 may carry the differential blue signals (i.e. blue+ and blue−).

For RGB video signals, the sync signals may be summed with the color components as illustrated in FIG. 2. For example, when the format to be transmitted is RGBHV (i.e. RGB with separate horizontal and vertical sync signals), the vertical sync signal may be summed with the red signal (i.e. Red/V Sync+ and Red/V Sync−); and the horizontal sync signal may be summed with the blue signal (i.e. Blue/H Sync+ and Blue/H Sync−).

When the format to be transmitted is RGBS (i.e. RGB with one composite sync signal), the composite sync signal may be summed with the blue signal (i.e. Blue/C Sync+ and Blue/C Sync−).

When the format to be transmitted is RsGsBs (i.e. each color component having its own sync signal), the sync signals may be summed with the respective color component signals as shown in FIG. 2.

When the format to be transmitted is RGsB (i.e. only the green color component has its own sync signal), the differential sync signals are summed with the corresponding green color signal as shown in FIG. 2.

Component video signals may be allocated such that pins 1 and 2 carry the differential red signals (i.e. “R-Y”+ and “R-Y”−); pins 4 and 5 may carry the differential luminance signals (i.e. Y+ and Y−); and pins 7 and 8 may carry the differential blue signals (i.e. “B-Y”+ and “B-Y”−).

For S-Video, the signals may be allocated such that pins 1 and 2 are not used for video; pins 4 and 5 may carry the differential luminance signals (i.e. Y+ and Y−); and pins 7 and 8 may carry the differential chrominance signals (i.e. C+ and C−). Pins 3 and 6 may carry power and digital communication signals.

For Composite Video, the signals may be allocated such that pins 1, 2, 7, and 8 are not used. Pins 4 and 5 carry the differential video signals (i.e. Video+ and Video−). Pins 3 and 6 may carry power and digital communication signals.

FIG. 3 shows another cable configuration that may be used with one or more embodiments of the present invention. In the configuration of FIG. 3, composite video and S-Video signals share the same twisted pair cable 106. As shown, the composite video signals may be allocated such that pins 1 and 2 may carry the differential video signals (i.e. “Composite Video”+

and “Composite Video”−); pins 4 and 5 may carry the differential luminance signals (i.e. Y+ and Y−); and pins 7 and 8 may carry the differential chrominance signals (i.e. C+ and C−). Pins 3 and 6 may carry power and digital communication signals, as necessary.

The following detailed description of various example embodiments of the present invention are presented using RGB video format. However, although the descriptions that follow refer to the RGB video format, it should be equally clear to those of skill in the art that the principles discussed herein are equally applicable to other video formats. For example, it should be understood that the video formats discussed with respect to FIGS. 2 and 3 are, at a minimum, equally applicable.

Referring back to FIG. 1, the transmitter 104 obtains the video and audio signals from the source 102, processes the signals and differentially transmits the video signals over twisted pair cable 106. FIG. 4 is a block diagram of transmitter 104 in accordance with an embodiment of the present invention.

The video signal received by transmitter 104 from video source 102 may have synchronization signals embedded in the video signal, or the synchronization signals may be provided to transmitter 104 over separate lines. As illustrated in FIG. 4, transmitter 104 comprises input amplifiers circuit 410, which receives the source signal from a video input 401. If separate synchronization signals are provided, synchronization processing circuit 430 receives those synchronization signals from synchronization input 431. Offset correction circuit 440 compensates for any DC offset in the source and output signals, and is arranged as shown, receiving input signals from synchronization processing circuit 430 and differential output amplifiers circuit 460, and outputting a compensation signal to input amplifiers circuit 410. Processing logic assures that the polarities of the internal synchronization signals are always appropriate for output regardless of the polarity of the input. Differential output amplifiers circuit 460 drives the differential (twisted pair) cable 401 with the outgoing signals.

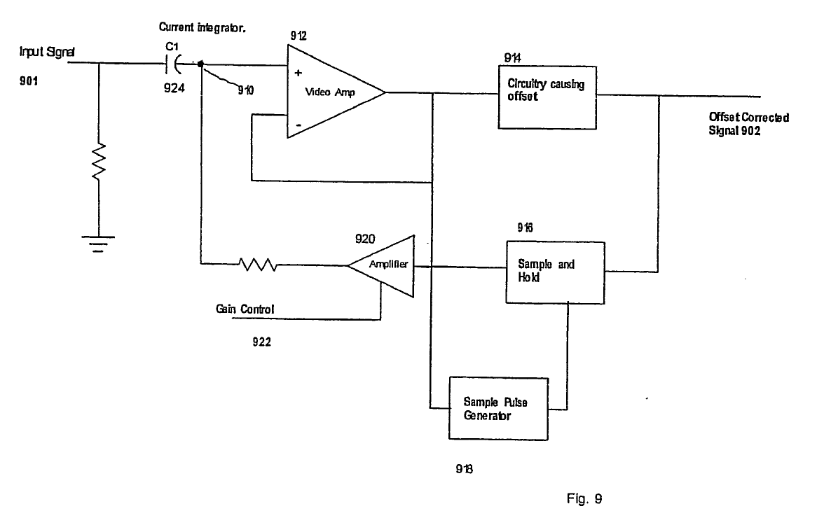

In the embodiment of FIG. 4, each of the video signal components (e.g. the R, G. or B component signals of an RGB video signal, or the Y, U, and V component signals of a component video signal), available through video input 401, is processed in a separate amplifier circuit in input amplifiers circuit 410. Using the synchronization signals (e.g. vertical and horizontal synchronization signals) from synchronization processing circuit 430 and the amplified video source signal from input amplifiers circuit 410, offset correction circuit 440 determines the DC offset in the output signal and applies the appropriate compensation in a feedback sense through input amplifiers circuit 410. Any DC offset in the source is blocked by the capacitor 403. The operation of DC offset correction circuit 440 in accordance with an embodiment of the present invention is discussed below with respect to FIG. 9.

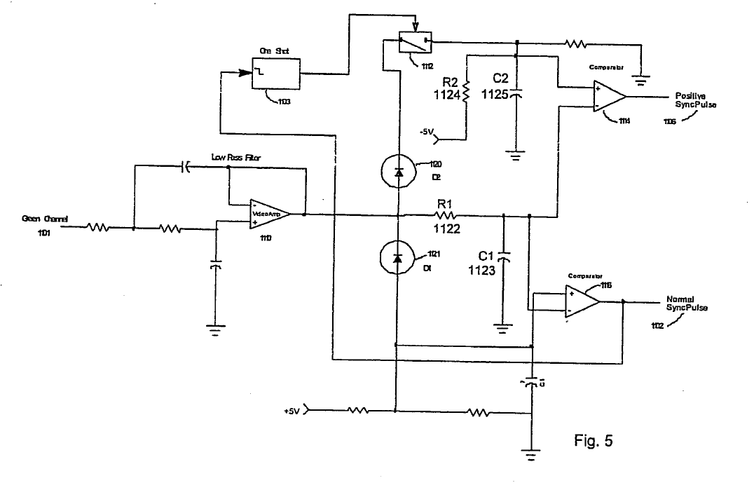

Synchronization processing circuitry 430 detects the vertical and horizontal synchronization signals either from synchronization input 431 or from analog sync detection circuit 434, an embodiment of which is illustrated in FIG. 5. The detected synchronization signals from block 430 may be subsequently mixed at summing junction 452 with the feedback corrected video source signals from block 410. Subsequently, the outputs of the summing junction 452, each of which may now comprise a color component and/or a synchronization (or “sync”) signal (as illustrated in FIG. 2), are routed to differential output amplifiers circuit 460 which drive the differential signals over twisted pair cable 402. The drive signals are a mix of the vertical and horizontal synchronization pulses with the RGB video components. Both video and synchronization signals may be transmitted on each of the R, G, and B twisted pair lines.

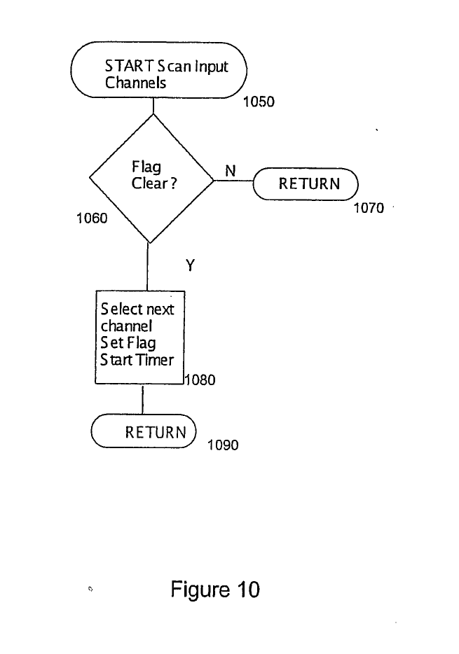

If no synchronization signal is provided to synchronization input 431, the synchronization signals may be embedded in the video signal obtained at video input 401. For a signal to be a synchronization signal, it must be periodic and its timing must be in a certain range. Analog synchronization detection circuitry 434 (which is discussed in greater detail below with respect to FIG. 5) conditions the embedded synchronization signal appropriately for synchronization processing circuit 430, which checks for the periodicity and timing limits. If those criteria are found to be consistent with a synchronization signal, the timing derived from the synchronization signal is used to center the transmitted video in the best region of operation for non-distorted transmission onto the differential pairs 402. Method steps used in one or more embodiments for characterizing a synchronization signal in a video input signal are described with respect to FIG. 10 below. In one or more embodiments, if a synchronization signal is already embedded in the input video signal, the synchronization signal output of synchronization processor 430 is not added to the video signal at summing junction 452.

When there is no synchronization signal provided to synchronization processor 430 (either from synchronization input 431 or from analog sync detector circuit 434), then no video signal is present. In that case, in one or more embodiments of the invention, the transmitter switches to a low gain continuous adjustment of the operating point.

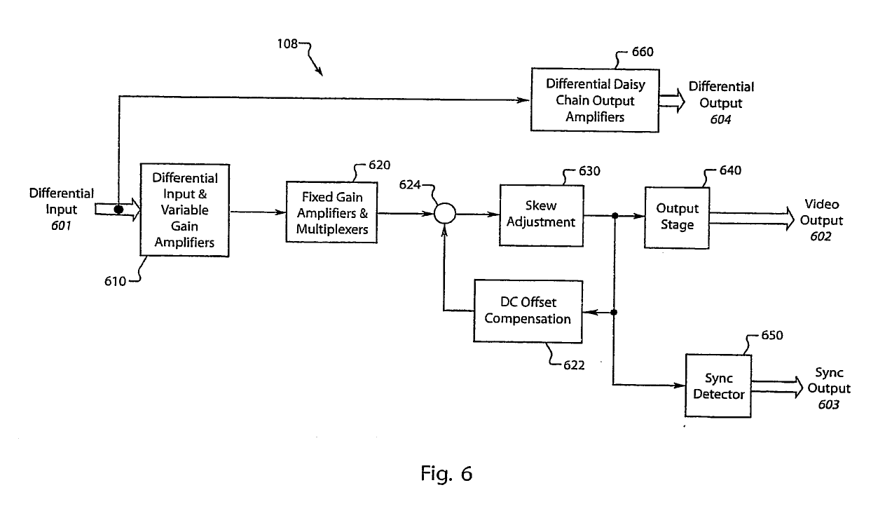

Referring back to FIG. 1, receiver 108 receives the differential video signals (and the corresponding audio signals) from transmitter 104 via the twisted pair cable 106. Receiver 108, as described in greater detail below, compensates and processes the differential video signals to compensate for losses and errors resulting from transmission over twisted pair 106, and then drives out the compensated video signals via cable 109 to destination device 110 (e.g. a video projector) for display. FIG. 6 is a block diagram illustration of receiver 108 in accordance with an embodiment of the present invention. For simplicity, the block diagram of FIG. 6 represents any one of the 3 channels or all the channels.

As illustrated in FIG. 6, receiver 108 comprises differential input and variable gain amplifiers circuit 610; fixed gain amplifiers and multiplexers circuit 620; skew adjustment circuit 630; output stage circuit 640; DC offset compensation circuit 622; and sync detector circuit 650. Receiver 108 may also include differential output connector 604 through differential daisy chain output amplifiers circuit 660, that may be used for daisy chaining other receivers to receiver 108.

The differential video input signals 601 (e.g. R+,R−; G+,G−; and B+,B− in the case of an RGB video format) are fed to differential input and variable gain amplifiers circuit 610. Differential input and variable gain amplifiers circuit 610 adjusts each video signal component (e.g. R) for DC to low frequency and high frequency losses due to transmission via twisted cable 106 from transmitter 104 to receiver 108. In one or more embodiments, the DC to low frequency gain and peaking (high frequency gain) adjustment made by differential input and variable gain amplifiers circuit 610 is limited to losses corresponding to transmission over a predetermined maximum cable length, e.g. 300 feet. In one or more embodiments, each video component (i.e. R, G, and B) is processed separately by differential input and variable gain amplifiers circuit 610; thus, differential input and variable gain amplifiers circuit 610 may be viewed as having three inputs (Rₓ, Gₓ, and Bₓ) and three outputs (R_{y}, G_{y}, and B_{y}).

The gain and peaking adjustment performed by differential input and variable gain amplifiers circuit 610 may be controlled, for example, using a micro-controller, that determines the appropriate compensation based on the actual and expected signal strength of a reference signal. For example, in one or more embodiments, a 1 MHz tone with a known amplitude is transmitted on one of the twisted pairs of a twisted pair bundle that is not used for transmission of the video signal (e.g. the pair referred to as pins 3 and 6 of FIG. 2). The measured amplitude of that signal at the receiver is used to adjust the DC gain so that the received measured level is the same as the transmitted level. Another tone at 7 MHz is also transmitted on the same pair. The difference in amplitude between the 1 MHz signal and the 7 MHz signal indicates the amount of compensation (“peaking”) required to restore the video signal. In one or more embodiments, the microcontroller comprises a Field-Programmable Gate Array (FPGA) in which a servo apparatus is implemented by appropriate programming. The servo apparatus compares the two gains (for the 1 MHz and 7 MHz signals) and automatically increases the peaking until the two levels are equal. The amount of gain required is used to indicate the effective distance the signal has traveled. This signal is used to automatically set the gain required for the other three (video) channels.

Fixed gain amplifiers and multiplexers circuit 620 provides additional compensation for longer cable lengths than can be compensated for by differential input and variable gain amplifiers circuit 610. For example, in one or more embodiments, fixed gain amplifiers and multiplexers circuit 620 is configured to provide additional compensation in discrete amounts that correspond to a predetermined cable length. For example, in one or more embodiments, fixed gain amplifiers and multiplexers circuit 620 adds compensation corresponding to integral multiples of a cable length of 300 feet. If this amount of compensation is referred to as “X,” then, for cable lengths of between 300 and 600 feet, fixed gain amplifiers and multiplexers circuit 620 provides “X” amount of compensation for the first 300 feet, and differential input and variable gain amplifiers circuit 610 add compensation for the remaining length (e.g. for 200 feet if the total length is 500 feet). Similarly, for lengths between 600 and 900 feet, fixed gain amplifiers and multiplexers circuit 620 provides “2X” amount of compensation, with differential input and variable gain amplifiers circuit 610 adding compensation for the remaining length, and so on. In one or more embodiments, fixed gain amplifiers and multiplexers circuit 620 provides up to “5X” amount or more of compensation.

Sync output 603, which is an output of sync detector 650, comprises horizontal and vertical sync signals. In one or more embodiments of the invention, the horizontal and vertical sync signals are generated by comparing the red (i.e. R_{y}) and the blue (i.e. B_{y}) outputs of skew adjustment circuit 630 against a negative voltage level. In one or more embodiments, a comparator is used for such comparison. The vertical sync signal is generated when the R_{y} output of skew adjustment circuit 630 meets the negative voltage threshold level; and the horizontal sync signal is generated when the B_{y} output of skew adjustment circuit 630 meets the negative voltage threshold level.

In one or more embodiments, skew compensation is performed through skew adjustment circuit 630. Skew adjustment is accomplished by first recovering the sync signal from each video output component, for example, at the output of skew adjustment circuit 630. In one or more embodiments, a microcontroller analyses the recovered sync signals to determine the appropriate amount of compensation to apply to each component signal through skew adjustment circuit 630 so that skew is eliminated among the various signal components (e.g. the R, G and B signals). In one or more embodiments, for skew adjustment to be performed, each color component that is transmitted from transmitter 104 to receiver 108 includes an embedded sync signal. For example, in one or more embodiments, transmitter 104 may be configured to add either the horizontal or vertical sync signal to each of the R, G and B component signals.

The sync signal for each color component may be detected in Sync Detector 650. For example, in one or more embodiments, the sync on the red signal, R_{sync}, is generated as the output of a comparator that compares the R_{y} output of skew adjustment circuit 630 to a negative voltage threshold. Similarly, the sync on the green signal, G_{sync}, is generated as the output of a comparator that compares the G_{y} output of skew adjustment circuit 630 to a negative voltage threshold. And finally, the sync on the blue signal, B_{sync}, is generated as the output of a comparator which compares the B_{y} output of skew adjustment circuit 630 to a negative voltage threshold.

DC offset compensation circuit 622 comprises a feedback loop around skew adjustment circuit 630. DC offset compensation circuit 622 measures the signal offset at the output of skew adjustment circuit 630 and generates a correction signal. The correction signal feeds back and sums with the gain compensated video signal (from fixed gain amplifiers and multiplexers circuit 620) in summing node 624. In one or more embodiments, DC offset compensation may be needed on the input of the skew adjustment circuit 630 because of large DC offsets associated with circuitry in the skew adjustment circuit 630. The operation of DC offset compensation circuit 622 in accordance with an embodiment of the present invention is discussed with respect to FIG. 9 below.

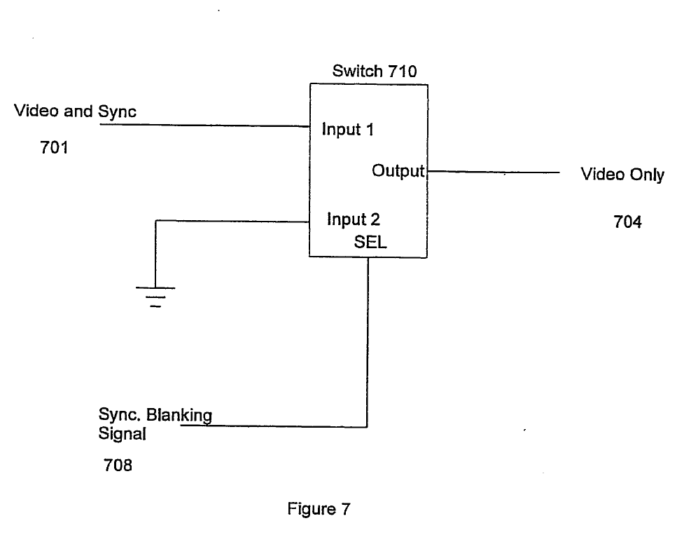

In one or more embodiments, video output 602 is generated by stripping any sync signals that may be present in any of the video signal components at output stage 640. In one or more embodiments, the sync stripping circuit in output stage 640 comprises a switch that grounds the video output during the sync period. In one or more embodiments, the circuit is such that when either the vertical sync or the horizontal sync pulse is active, video output 602 is switched to ground; otherwise, video output 602 is switched to the corresponding video signal output of skew adjustment circuit 630. An example embodiment of a sync stripping circuit used in one or more embodiments is illustrated in FIG. 7.

In the embodiment illustrated in FIG. 7, video and sync signal 701 is a video component signal comprising an embedded sync signal received from the output of skew adjustment circuit 630. Video signal 704 is the stripped video output from which the sync signal has been removed. Sync blanking signal 708 may be obtained from sync detector 650 or may be generated by a Field Programmable Gate Array (FPGA) that predicts the time of the regular sync signals. When the sync blanking signal 708 selects input two of switch 710, video output signal 704 is coupled to ground through switch 710 to remove the sync pulse. Otherwise, i.e. when the sync blanking signal 708 selects input 1 of switch 701, video output signal 704 is coupled to video and sync signal 701, which, during that time, does not include a sync signal.

In one or more embodiments, DC offset compensation/correction is applied in both the transmitter and receiver. The DC offset correction of the video signal in the transmitter may be useful if an input source is used that has a floating reference voltage, or that is biased above or below ground. In the receiver, DC offset correction may be useful because of circuitry within the receiver that may cause DC offset.

In one or more embodiments, DC offset correction involves adjustment of the video signal with respect to ground. Determining the amount of correction required involves detecting the offset voltage level. In one or more embodiments of the invention, the offset voltage is detected by sampling the “back porch” of the video signal to obtain a reference voltage level for the video signal. The voltage at the back porch of video signals is typically zero or the center of the signal's dynamic range. Measuring the voltage level at the back porch produces an offset voltage, which may be continuously applied to the video signal through a feedback path, until the back porch is restored (or adjusted) to a ground level.

To find the back porch, one or more embodiments of the present invention use the trailing edge of the horizontal sync signal to trigger sampling of the video signal to determine the back porch DC level. For example, in one or more embodiments, a circuit is provided that generates a sample pulse during the back porch time. This sample pulse is subsequently used to control a sample and hold circuit, which samples the output video signal during the sample pulse period and generates an offset voltage equivalent to the back porch voltage level. The offset voltage is fed back negatively to remove the DC offset.

FIG. 9 is an illustration of an example of a DC restore circuit used in one or more embodiments of the present invention. In the embodiment of FIG. 9, the DC restore circuit comprises error integrating node 910, amplifier 912, circuitry causing offset 914, sample and hold circuit 916, and sample pulse generator circuit 918. In one or more embodiments, these elements are arranged as shown in FIG. 9, but may be configured differently in other embodiments. The DC restore circuit of FIG. 9 operates on an input signal 901 to generate a sampled video signal, namely offset corrected signal 902. Offset corrected signal 902, the output of sample and hold circuit 916, is generated when a sample pulse is received sample pulse generator 918 (which, as discussed above, generates a sample pulse during the back porch of the video signal).

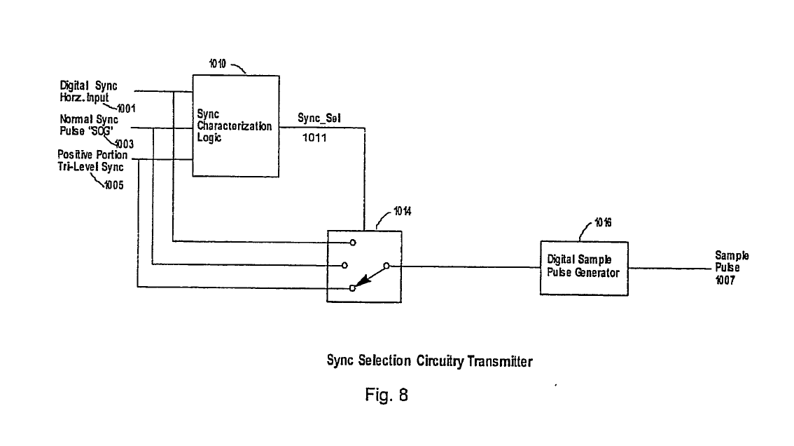

In one or more embodiments, sample pulse generator 918 is implemented as part of sync processing circuit 430 of FIG. 4. FIG. 8 shows an embodiment of a portion of sync processing circuit 430 that generates a sample pulse 1007 in one or more embodiments of the invention. The embodiment of FIG. 8 is configured to operate on a variety of video formats. To accommodate various video formats, three separate types of sync input signals are provided for, namely horizontal digital sync input signal 1001, normal sync input signal 1003, and positive portion of tri-level sync input signal 1005. In one or more embodiments, horizontal digital sync input signal 1001 is obtained from synchronization input 431 if the video signal is of the RGBHV or RGBS video formats. In one or more embodiments, normal sync input signal 1003 (which may, for example, be a sync signal embedded in the green (G) component video signal) and/or positive portion of tri-level sync input signal 1005 are obtained from analog sync detection circuit 434. In the embodiment of FIG. 8, it is assumed that the separate synchronization signal, digital horizontal sync input signal 1001, has been normalized such the smallest time between transitions bracket the active portion of the sync pulse. In one or more embodiments, sync characterization logic circuit 1010 may select any of the three input pulses, namely digital horizontal sync input signal 1001, normal sync input signal 1003, or the positive portion of tri-level sync input signal 1005, based on characteristics of the signals. In one or more embodiments, sync select signal 1011 remains high as long as digital horizontal sync input signal 1001 periodically pulses the sync characterization logic 1010. The sample pulse 1007 is generated off the trailing edge of the sync pulse.

FIG. 5 shows an embodiment of a circuit that is used to extract a normal sync signal and a positive portion of a tri-level sync signal from a green component video signal in one or more embodiments of the invention. The embodiment of FIG. 5 may be used, for example, if the video source is of a format that does not provide a separate digital sync signal. The circuit of FIG. 5 comprises a sync pulse generator that generates a positive-going horizontal sync pulse from the green video input signal 1003 (i.e. Sync-On-Green or “SOG”). In one or more embodiments, the circuit of FIG. 5 also generates positive portion of tri-level sync signal 1005.

The circuit of FIG. 5 comprises a low pass filter comprising active video amplifier 1110 which provides a low-pass filtered version of green video input signal 1101 to diode D1 1121 and to the negative input of comparator 1116. Comparator 1116 is used to detect the negative sync tip and generate a synchronization pulse, namely normal sync pulse signal 1102. In the embodiment of FIG. 5, the circuitry comprising diode D1 1121, resistor R1 1122 and capacitor C1 1123 acts as a sync tip sample. That is, this circuitry detects and holds the lowest level voltage in the filtered incoming signal received from video amplifier 1110. Subsequently, the sync tip (or lowest detected voltage level) is compared to the incoming signal in comparator 1116 to generate the normal sync pulse signal 1102. Normal sync pulse signal 1102 is the active input to a pulse generator, one-shot 1103, that in turn drives the sample switch 1112. Diode D2 1120, switch 1112, resistor R2 1124, and capacitor C2 1125 sample the sync voltage level on the trailing edge of the incoming negative sync signal. If there is tri-level sync, switch 1112 will be on, causing capacitor C2 1125 to charge to the positive tip of the tri-level sync signal. If there is bi-level sync, then comparator 1114 slices similarly to comparator 1116, but if there is tri-level sync, the resulting positive sync pulse 1106 will not coincide with that normal sync pulse 1102. Instead, positive sync pulse 1106 will be staggered relative to normal sync pulse 1102.

Referring to FIG. 8, switch circuit 1014 selects digital horizontal sync input signal 1001 as the source for generating the sample pulse 1007 so long as the sync select signal 1011 points to digital horizontal sync input signal 1001. However, if the sync select signal 1011 deselects digital horizontal sync input signal 1001 (i.e. when there is no separate sync signal), normal sync input signal 1003 is used to generate the sample pulse 1007. That will typically be the case for video formats such as RGsB, RsGsBs, component, S-video and composite. Component video typically will include a tri-level sync. For component video that includes a tri-level sync signal, as discussed above, the positive portion of tri-level sync input signal 1005 will typically be staggered so as to not be coincident with normal sync input signal 1003. In that case, in one or more embodiments, switch 1014 points to the positive portion of tri-level sync input signal 1005 instead of normal sync input signal 1003 for generating sample pulse 1007.

If the video signal is a HDTV signal, in one or more embodiments, the circuit of FIG. 5 examines the relationship of the pulses from the positive sync signal 1106 relative to pulses from normal sync signal 1102. If the two pulses are staggered and not overlapping then the circuit is experiencing tri-level sync. In that case, in one or more embodiments, the DC sampling pulse takes place after the trailing edge of the positive sync pulse signal 1106.

In the embodiment of FIG. 8, input to the pulse generator 1016 at the trailing edge of the applicable sync signal is controlled by switch 1014. In one or more embodiments, because the trailing edge of the sync signal signifies the back porch, pulse generator circuit 1016 is configured to trigger a fixed width pulse starting at the trailing edge of the sync signal (i.e. output of switch 1014). The output of pulse generator circuit 1016 represents the sample pulse 1007.

As previously stated, the sample pulse is generated at the time of the back porch, which occurs after the synchronization signal. Once the appropriate sync signal is selected at the output of switch 1014, the trailing edge is used to generate sample pulse 1007 with a fixed sample width, via a pulse generator 1016. In one or more embodiment the pulse width of the sample pulse 1007 is based upon a minimum amount plus a small percentage of the total time for a line.

Referring back to FIG. 9, the sample pulse (i.e. the output of sample pulse generator 918) causes sample and hold circuit 916 to obtain the offset voltage value of the back porch from the output signal (i.e. offset corrected signal 902). The offset voltage is integrated away (subtracted) from the incoming signal (i.e. input signal 901) at integrating node 910. That is, the complement of the offset voltage is used as feedback to the integrating node 910. Typically, the voltage across capacitor C1 924 is based on its charge alone. The feedback creates a current that adjusts the resulting back porch voltage of offset corrected signal 902 to a value of 0 volts, and it compensates for the effects of load side leakage currents into the capacitor. In one or more embodiments, the output signal being sampled (i.e. offset corrected signal 902) is the output of the circuitry causing the offset 914. In other embodiments, in which offset exists in the incoming video signal, the output signal being sampled is that of amplifier 912. In such embodiments, the circuitry causing offset 914 is compensated for as well. Typically, the capacitor C1 924 blocks any DC offset prior to it, and the feedback circuit only has to compensate for errors introduced subsequently to the capacitor C1 924, and for errors caused by any leakage currents into the capacitor C1 924 from the amplifier 912.

Various methods are used to validate sync pulses in one or more embodiments of the invention. In the transmitter, the VGA sync lines may or may not have sync on them. It depends on the video type (RGB-HV, RGBS, or RGsB). In one or more embodiments, two vertical sync duration detectors are used, one for the vertical sync inputs, and one for the horizontal sync input. If vertical sync is detected on the horizontal sync input, then the video type is RGBS. If vertical sync is not detected on either the horizontal or the vertical sync inputs, then the video type is possibly SOG. If no vertical sync is detected on either the horizontal or vertical inputs, and there is no sync on Green, then no sync is available and the line has no video. Loss of sync immediately means no video.

On the output side, only RGB-HV needs V drive out. Only RGB-HV and RGBS require H drive out.

FIGS. 10-12 show method steps used to validate sync pulses in one or more embodiments of the invention.

FIG. 10 shows method steps used in one or more embodiments to time the check of the various possible sync sources so that there will be enough time to generate the data for analysis. As shown in FIG. 10, a scan of the input video channels is started at step 1050. At step 1060, a determination is made as to whether a flag has been set indicating that a channel is being analysed. If there a flag has been set (i.e. “Flag Clear” is false), the process returns at 1050. If no flag has been set, the next channel is selected for analysis at step 1080. Also, a flag is set, and a timer is started. In one or more embodiments the length of the time is chosen to allow sufficient time for analysis of the channel to be completed. The process then returns at step 1090.

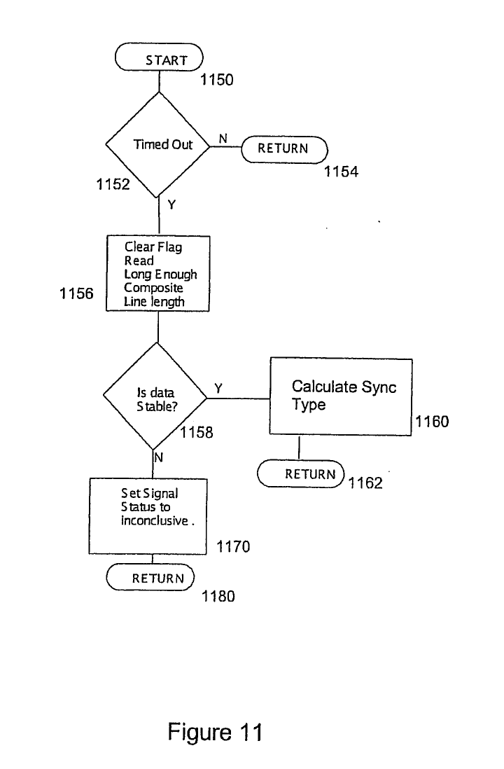

FIG. 11 shows method steps used to analyze a channel in one or more embodiments. The process starts at step 1150. At step 1152, a determination is made as to whether the timer set for analysis of the channel (e.g. the timer set at step 1080 of FIG. 10) has timed out. If the timer has not timed out, the process returns at step 1154.

If the timer has timed out, the flag is cleared at step 1156, and “Long Enough”, “Composite”, and “Line Length” signals are read. In one or more embodiments, the “Long Enough” signal is true when a sync pulse of 6 microseconds or greater is detected on the digital Vertical input pin of the VGA connector. In one or more embodiments, the “Composite” signal is true when the 6 microsecond pulses are detected on the H Sync input of the VGA connector.

At step 1158, a determination is made as to whether the data read at step 1156 is stable. If the data is not stable, the signal status is set to inconclusive at step 1170, and the process returns at step 1180.

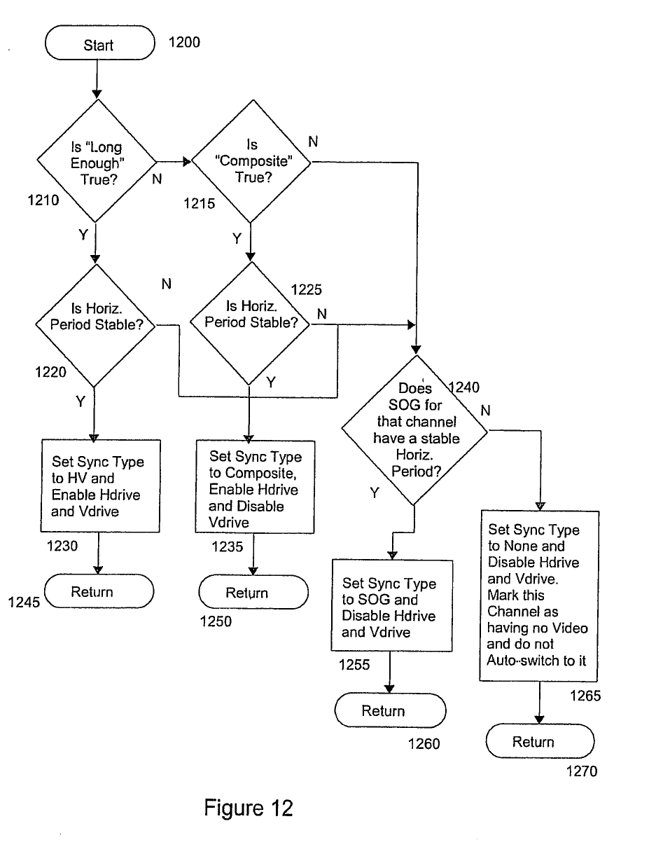

If at step 1158 it is determined that the date is stable, the sync type of the signal for the channel being analyzed is calculated at step 1160. In one or more embodiments, the method shown in FIG. 12 may be used to calculate the sync type. After the sync type has been calculated, the process returns at step 1180.

FIG. 12 shows method steps used to calculate a sync type in one or more embodiments. The method of FIG. 12 may be used, for example, in step 1160 of the embodiment of FIG. 11.

The process starts at step 1200. At step 1210, a determination is made as to whether the “Long Enough” signal is “true.” If the “Long Enough” signal is found to be true at step 1210, a check is made at step 1220 to determine whether the horizontal period is stable. In one or more embodiments, the horizontal period is considered stable when the line duration count does not very more than 5% over several tests. If the horizontal period is found to be stable at step 1220, the sync type is set to HV and horizontal and vertical drive signals are enabled. The process returns at step 1245.

If the horizontal period is found not to be stable at step 1220, a determination is made at step 1240 as to whether the Sync-on-Green for that channel has a stable horizontal period. If it does, the sync type is set to SOG at step 1255 and the horizontal and vertical drive signals are disabled. The process returns at step 1260.

If it is determined at step 1240 that there is no stable horizontal signal for the SOG for that channel, the sync type is set to “none” at step 1265. In addition, the horizontal and vertical drive signals are disabled, and the channel is marked as having no video and not to be autoswitched-to. The process returns at step 1270.

If the “Long Enough” signal is found to be not true at step 1210, a determination is made as to whether the “Composite” signal is true at step 1215. If the “Composite” signal is found to be true, a determination is made at step 1225 as to whether the horizontal period is stable. If the horizontal period is stable, the sync type is set to composite, the horizontal drive signal is enabled, and the vertical drive signal is disabled at step 1235. The process returns at step 1250.

If the horizontal period is determined to be not stable at step 1225, the process proceeds to step 1240, and continues from there as described above.

In one or more embodiments, the process of FIGS. 10-12 is performed continuously because the input signal type may change over time.

It will be understood that the above described arrangements of apparatus and the method steps are merely illustrative of applications of the principles of this invention and many other embodiments and modifications may be made without departing from the spirit and scope of the invention as defined in the claims.

What is claimed is:

1. An apparatus for improving the quality of an output video signal comprising:
a pulse generator circuit that generates a sample pulse from a trailing edge of a synchronization signal associated with said output video signal;
a sampling circuit coupled to said output video signal and said sample pulse that generates an output error signal by sampling said output video signal to obtain an offset signal; and
an integrating circuit that applies a complement of said offset signal to an input video signal to reduce said output error signal.

2. The apparatus of claim 1, wherein said input video signal comprises at least one component of a formatted video signal.

3. The apparatus of claim 2, wherein said at least one component of said input video signal comprises:
a red component of an RGB formatted video signal;
a green component of said RGB formatted video signal; and
a blue component of said RGB formatted video signal.

4. The apparatus of claim 3, wherein said green component of said RGB formatted video signal includes said synchronization signal.

5. The apparatus of claim 2, wherein said at least one component of said input video signal comprises:
a Y component of an YUV formatted video signal;
a U component of said YUV formatted video signal; and
a V component of said YUV formatted video signal.

6. The apparatus of claim 1 further comprising a sync selection circuit that selects a type of synchronization signal used by said pulse generator circuit from a group comprising a digital horizontal synchronization signal, a normal (bi-level) synchronization signal, and a positive portion of a tri-level synchronization signal 1.

7. The apparatus of claim 6, wherein said sync selection circuit comprises:
a sync-signal detection circuit coupled to an input synchronization signal for generating a sync selection signal;
a selector circuit controlled by said sync selection signal and having a first input coupled to an input synchronization signal, a second input coupled to a green component of said input video signal, a third input connected to a positive portion of a tri-level synchronization signal, and an output coupled to said pulse generator circuit.

8. A method for improving the quality of an output video signal comprising:
obtaining a synchronization signal from an input video signal, said synchronization signal having a synchronization pulse with a front edge and a trailing edge;
generating a sample pulse signal corresponding to said trailing edge of said synchronization pulse;
generating an offset signal by sampling an output video signal using said sample pulse signal; and
generating said output video signal by integrating a counteracting bias signal with said input video signal.

9. The method of claim 8, wherein said input video signal comprises at least one component of a formatted video signal.

10. The method of claim 9, wherein said input video signal comprises one or more of the following:
a red component of an RGB formatted video signal;
a green component of said RGB formatted video signal; and
a blue component of said RGB formatted video signal.

11. The method of claim 10, wherein said green component of said RGB formatted video signal includes said synchronization signal.

12. The method of claim 8, wherein said step of generating a sample pulse comprises:
generating a selection signal from a first one-shot circuit coupled to said synchronization signal;
generating a selected synchronization signal by using said selection signal in selecting one of a group of synchronization signals comprising a horizontal synchronization signals and a second synchronization signal derived from a green component of said input video signal; and
generating said sample pulse signal based on a trailing edge of said selected synchronization pulse signal.

13. The method of claim 12 wherein said second synchronization signal comprises a positive part of a tri-level synchronization signal.

14. A method for improving the quality of an output video signal comprising:
obtaining a synchronization signal from an input video signal, said synchronization signal comprising a synchronization pulse with a front edge and a negative portion with a trailing edge;
determining whether said synchronization pulse further comprises a positive portion with a trailing edge;
generating a sample signal at said trailing edge of said positive portion of said synchronization pulse if said synchronization pulse comprises said positive portion;
generating a sample signal at said trailing edge of said negative portion of said synchronization pulse if said synchronization pulse does not comprise said positive portion;
generating an offset signal by sampling said output video signal using said sample signal; and
generating said output video signal by applying a counteracting bias signal to said input video signal.

15. The method of claim 14, wherein a Y component of a component formatted video signal comprises said synchronization signal.

16. The method of claim 15 wherein said sample signal is generated at said trailing edge of said positive synchronization pulse.

17. The method of claim 16 wherein said output video signal is corrected by integrating said counteracting bias voltage with said input video signal.

18. The method of claim 16, wherein said output video signal is corrected by subtracting said counteracting voltage from said input video signal.

19. The method of claim 14 wherein said output sample signal turns on all the time causing an amplifier to be maintained in an active region when no input video is present.
